(19) United States
(12) Patent Application Publication
(10) Pub. No.: US 2007/0265921 A1
(43) Pub. Date: Nov. 15, 2007

(54) Hierarchical referral system

(75) Inventors: Nathan D. Rempe, Omaha, NE (US); Barry S. Major, Omaha, NE (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Nebraska Book Company, Lincoln, NE (US)

(21) Appl. No.: 11/796,678

(22) Filed: Apr. 27, 2007

Related U.S. Application Data
(60) Provisional application No. 60/796,596, filed on May 1, 2006.

(51) Int. Cl. G06Q 30/00

(52) U.S. Cl. 705/14

(57) ABSTRACT

A hierarchical referral system. The system includes a user interface configured to enable a referrer to create an electronic message. The system also includes a computation component that generates a unique electronic coupon and a unique electronic enrollment invitation. A message handling component attaches both the electronic coupon and the electronic enrollment invitation, generated by the computation component, to the electronic message and dispatches the electronic message to a referree. The attached electronic coupon represents a purchase incentive at a participating merchant and the electronic invitation represents an offer to enroll in a referral network of the referrer.

### BACKGROUND

The disclosure relates to a method of generating and increasing patronage. More particularly, the disclosure relates to a hierarchical coupon and commission based referral system.

Traditional methods of advertising have called for merchants making announcements through many media avenues. These avenues include television, radio, newspapers, direct mail, magazines, celebrity endorsements and other similar endorsements. The announcements are often verbal as with radio, or written, as with the printing of coupons in newspapers. These methods are usually very expensive, very time consuming, and often have to be paid for by merchants in advance, and without any guarantee of future sales. Air time and periodical space are often sold at a premium. Designing advertisements, doing research to define the exact target audience, and choosing where, when and how to place the advertisements are burdensome. This is sometimes so complicated and so demanding that additional employees or outside agencies are often hired to take care of such details.

As an alternative, some retail businesses have turned to multi-level marketing, in which merchants hire independent contractors who are paid on a commission basis. These contractors themselves solicit the services of other independent contractors, and receive compensation for a portion of the sales attributable to those individuals. In general, such systems require the retail business to organize and maintain a widely diffuse sales network and to arrange for product distribution to numerous sellers, thereby bypassing conventional distribution channels and their cost efficiencies.

What is needed, therefore, is a marketing approach that comports with existing sales and distribution patterns but does not involve the direct expenditures associated with traditional advertising.

### SUMMARY

A hierarchical referral system that addresses at least some of the above-mentioned problems with conventional marketing approaches is provided. The system includes a user interface configured to enable a referrer to create an electronic message. The system also includes a computation component that generates a unique electronic coupon and a unique electronic enrollment invitation. A message handling component attaches both the electronic coupon and the electronic enrollment invitation, generated by the computation component, to the electronic message and dispatches the electronic message to a referree. The attached electronic coupon represents a purchase incentive at a participating merchant and the electronic invitation represents an offer to enroll in a referral network of the referrer.

This summary is not intended to describe each disclosed embodiment or every implementation of the hierarchical referral system. Many other novel advantages, features, and relationships will become apparent as this description proceeds. The figures and the description that follow more particularly exemplify illustrative embodiments.

### BRIEF DESCRIPTION OF THE DRAWINGS

FIG. 1A is a simplified block diagram of a hierarchical referral system.

FIG. 1B is a simplified block diagram showing components of a user interface of the hierarchical referral system of FIG. 1A.

FIG. 2 is a diagrammatic illustration of a hierarchy of individuals in a hierarchical referral system.

FIG. 3 shows a table with data illustrating an example commission structure in one embodiment of the hierarchical referral system.

While the above-identified figures set forth one or more embodiments of the hierarchical referral system, other embodiments are also contemplated, as noted in the disclosure. In all cases, this disclosure presents the hierarchical referral system by way of representation and not limitation. It should be understood that numerous other modifications and embodiments can be devised by those skilled in the art which fall within the scope and spirit of the principles of this disclosure.

### DETAILED DESCRIPTION

Disclosed here is a hierarchical referral system and method. The hierarchical referral system comprises a user interface which enables an individual, not previously associated with the system, (an “individual”) to create a hierarchical referral system network (a “referral network”) or join an existing referral network. The user interface also enables a hierarchical referral system user (a “member”) to create an electronic message (an “electronic message”). The hierarchical referral system also includes a computation component that can generate a unique, printable, electronic coupon or a unique mobile text (for example, a short message service (SMS) text message) based electronic coupon (each an “electronic coupon” and collectively the “electronic coupons”). The computation component can also generate a unique invitation to enroll an individual in the hierarchical referral system at a specific location in the referring member's referral network (an “electronic invitation”). The system also includes a message handling component that attaches the electronic coupon and/or electronic coupons to the message, and/or, attaches the electronic invitation (where applicable) to the message, and then dispatches the message to an individual or member (representing a “referral”). A member of the hierarchical referral system that uses the system to create the referral is referred to herein as a “referrer,” and the target of the referral is referred to herein as a “referree.” The system further includes an in-store point of sale component that accepts an electronic coupon and provides the corresponding purchase discount and related commission. An attached electronic coupon represents an incentive to purchase merchandise at participating merchants, local to the member, (each a “merchant” and collectively the “merchants”). An attached electronic invitation represents an offer to enroll in the referral network of the referrer, and is only created and attached to the electronic message if the recipient (referree) is not already a member of the hierarchical referral system. Electronic coupons are only redeemable at participating merchants. A user that possesses the highest level of access authority to the hierarchical referral system is referred to herein as the “owner” of the hierarchical referral system. In general, by using both electronic commerce and face-to-face transactions, the hierarchical referral system can increase patronage while comporting with existing sales and distribution patterns.

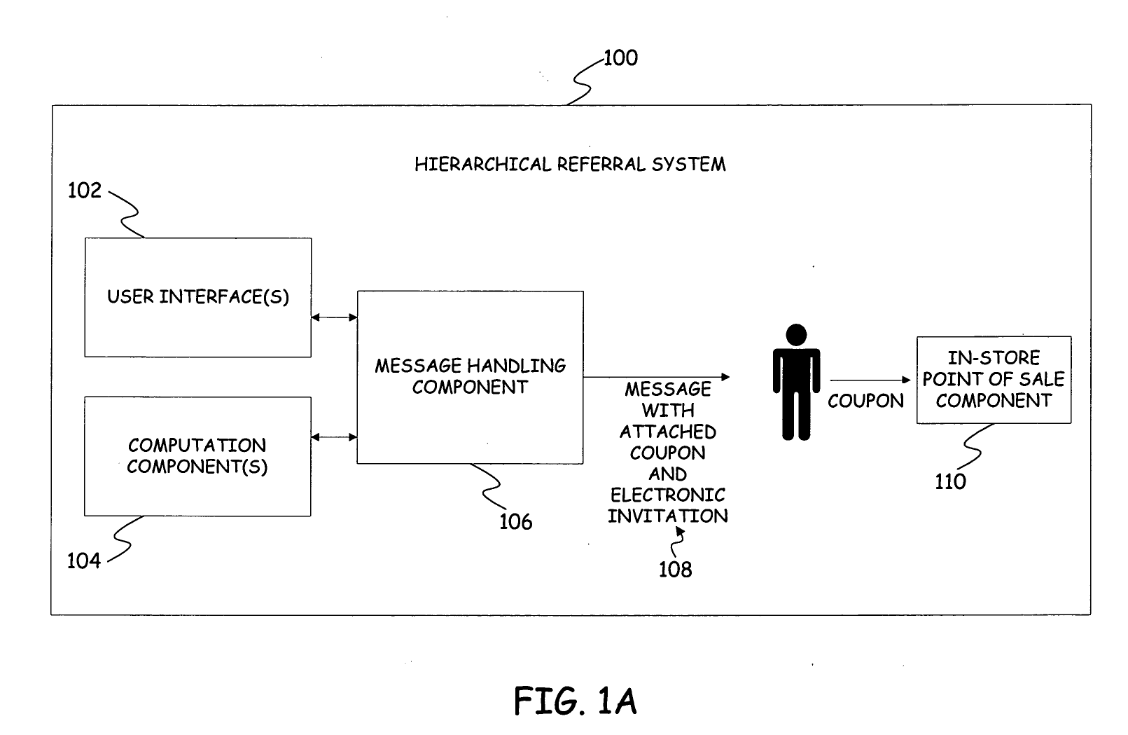

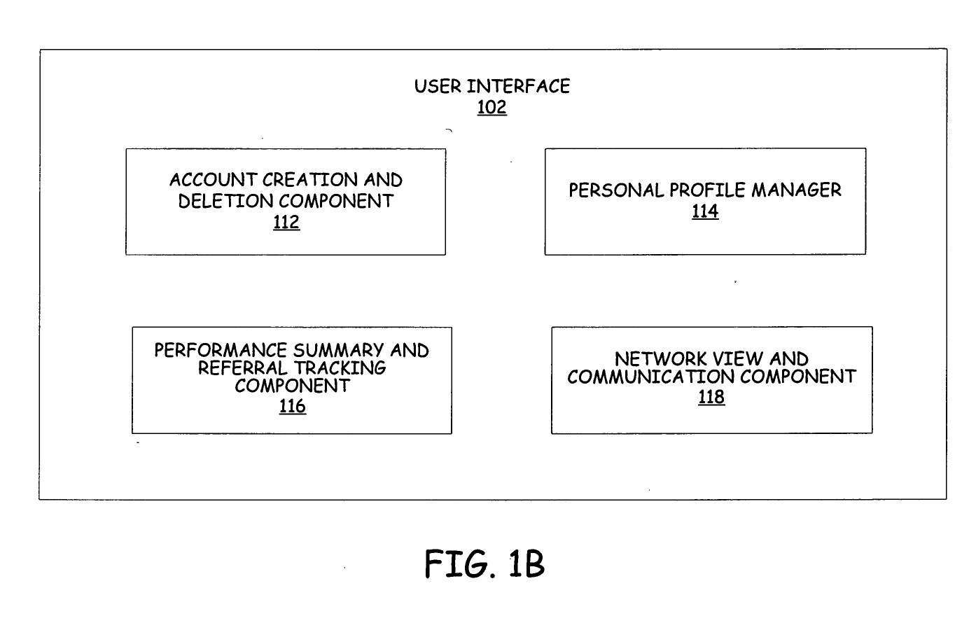

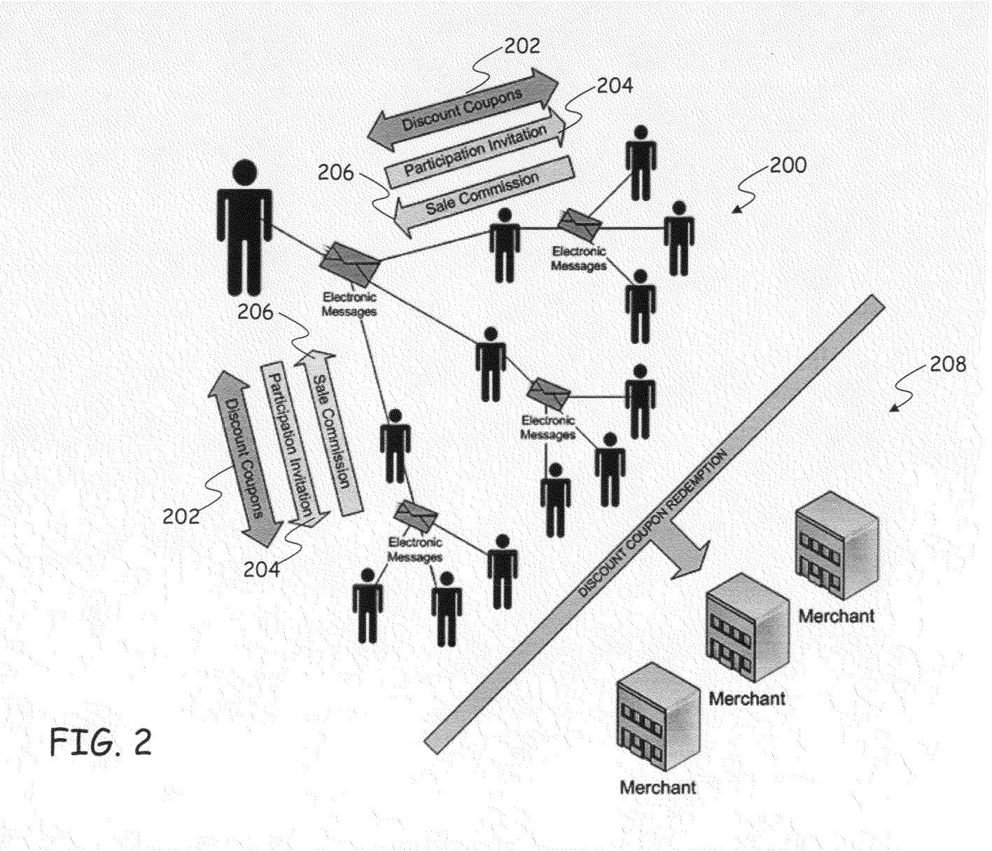

FIG. 1A is a simplified block diagram of a hierarchical referral system 100. System 100 includes, as its primary components, a user interface 102, a computation component 104, a message handling component 106 and an in-store point of sale component 110. User interface 102 enables a member to create an electronic message with an attached electronic coupon and/or coupons and an attached electronic invitation that can be sent to an individual. In some embodiments, at least a portion of the electronic message, the electronic coupon and the electronic invitation are unique and generated automatically. If desired, the member can modify the automatically generated electronic message. In some embodiments, user interface 102 can include a user authentication sub-component. Computation component 104 generates an electronic coupon, which is described in detail further below. The electronic coupon and electronic invitation are preferably generated after the member has completed the electronic message and clicks on a button to initiate the attachment of the coupon and/or coupons and the delivery of the message. Message handling component 106 attaches the electronic coupon and electronic invitation (where applicable) to the electronic message, thereby forming a referral, and dispatches the referral to the individual (referree). In certain embodiments, entering an email address and/or a mobile telephone number will automatically generate a referral. The attached electronic coupon represents a purchase incentive and an offer to enroll in a referral network of the member sending the referral (the referrer). The electronic coupon is redeemable at a merchant that is participating in the hierarchical referral system. Redemption of the electronic coupon is carried out with the help of in-store point of sale component 110, which is configured to accept the electronic coupon and to responsively provide a corresponding purchase discount and a related commission. Further details regarding the redemption of coupons are provided below in connection with FIG. 2.

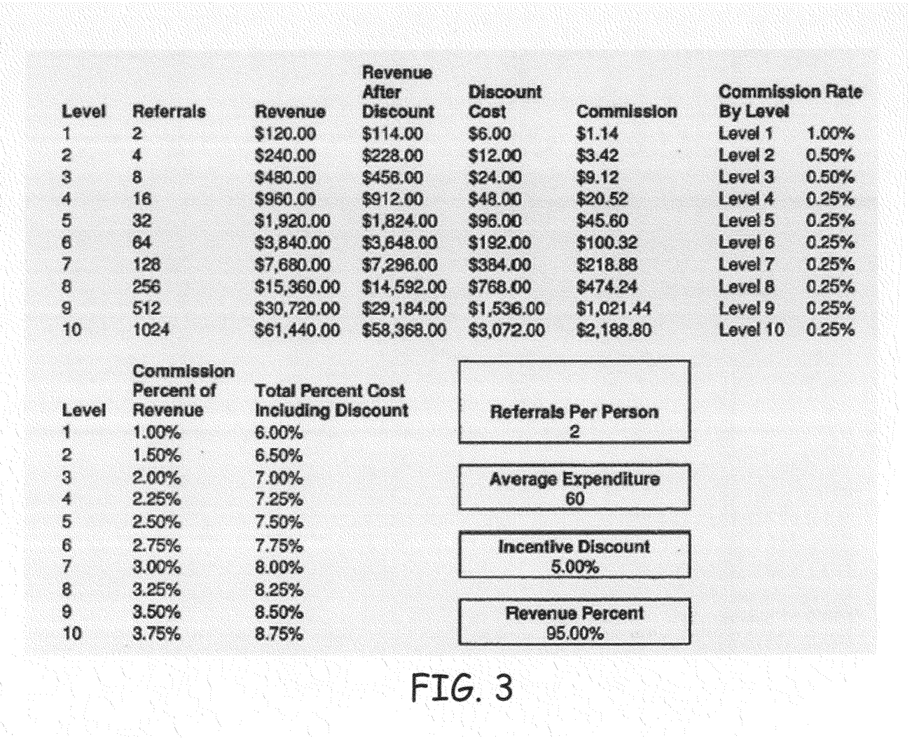

In one embodiment of the hierarchical referral system, a substantial portion of the hierarchical referral system comprises an internet website having a number of web pages. Therefore, user interface 102 can be viewed as including a number of pages or components that carry out substantially separate functions. Example components that are included in an embodiment of user interface 102 are shown in FIG. 1B. The example components are an account creation and deletion component 112, a personal profile manager 114, a performance summary and referral tracking component 116, and a network view and communication component 118. Example functions that can be carried out using these components are described below in connection with FIGS. 2 and 3, which together illustrate a specific embodiment of a hierarchical referral system utilized in connection with the sale of textbooks and trade books.

FIG. 2 is a diagrammatic illustration of a hierarchy of members 200 in a hierarchical referral system. The hierarchical referral system is “a hierarchical online coupon and commission based referral and recruitment system” designed to allow members to gain exponential monetary rewards for building a referral network that refers sales to participating merchants, to allow individuals and members to gain discounts on merchandise at participating merchants, and to allow merchants to gain patronage while comporting with existing sales and distribution patterns. Percent of sale monetary commissions flow all the way up a referral network hierarchy, with percentage varying by tier of the hierarchy and commissions being distributed to each branch, thereby creating incentives for members to send referrals and build a “bigger” referral network.

Individuals can easily sign up and participate in the referral system. In fact, building a referral network is one of the goals of the system. To participate in the hierarchical referral system, an individual must either blindly sign up as a new member or be referred by an existing member. Once enrolled, entering an email address and/or a mobile phone number of an individual into the hierarchical referral system will generate a referral.

A referral includes three elements:
1) Customizable text informing a recipient (referree) of the nature and purpose of the message;
2) An email based, printable coupon or a mobile text message (for example, a short message service (SMS) text message) based coupon, offering the referree a discount (for example, a single 5% discount) on purchases made at a local participating merchants; and
3) An offer to join the referrer's referral network where the referree can start sending referrals to others and gain monetary rewards.

The hierarchical referral system creates a unique incentive program for members to distribute electronic coupons for discounts on merchandise at brick and mortar locations of participating merchants, local to the member. For each coupon a member distributes and is used by an individual or another member to make a purchase, the referring member (referree) will receive a percentage of the sale involving that coupon. Members can recruit other individuals into the program and those individuals can recruit more individuals, creating a network of electronic coupon distributors. For each coupon used, all members involved in the referral receive a percentage of the profits from the sale based on their tiered location in the related referral network hierarchy. An individual does not have to be a member of the hierarchical referral system to receive and use an electronic coupon at a participating merchant.

The hierarchical referral system is designed to allow members in the referral network of another member to be at the top of their own referral network hierarchy. A member does not have to be at the top of a hierarchy to earn commissions. It is very possible, due to the reduction in percentage commission earned as levels increase, that a member at the top of a referral network could make less commission than a member several levels below in the same referral network. For this reason, everyone has an incentive to recruit additional individuals, no matter where they are in the hierarchy of the referral network.

In one embodiment, the hierarchical referral system is not directly associated with a merchant and is not a part of a merchant website. However, a merchant's website may contain online or offline advertisements regarding the program or link to the hierarchical referral system website. That merchant will thus appear as a “merchant participant” within the hierarchical referral system.

At the core of the referral network is the hierarchical inclusion of members that distribute and use electronic coupons at local merchants and pass commissions from these electronic coupons back up the hierarchy of the merchant. In FIG.2, the distribution of electronic coupons is denoted by reference numeral 202, the sending of participation invitations is denoted by reference numeral 204, the passing of commissions is denoted by reference numeral 206 and the redemption of discount coupons from merchants is denoted by reference numeral 208.

FIG. 3 is an example commission structure for a single member who refers two sales, with each individual executing the sale, enrolling in the referral system and referring two additional sales. In the context of textbook sales, the sample is based on a relatively modest sixty dollar ($60.00) merchant purchase minus a five percent (5%) discount purchase incentive (electronic coupon). In this example, members would earn commissions according to the structure shown in FIG. 3

In one embodiment, the hierarchical referral system allows a maximum of 10 commission tiers or levels, with tiers greater than 10 allowed, but non-commissioned. An administratively configurable incentive discount and commission rate can be controlled by individual participating merchants. Members have the ability to use electronic coupon for personal use at all merchant locations, allowing the referral system to deliver all members some benefit regardless of commission earned.

The hierarchical referral system includes a website where individuals can create an account, at no cost. The individuals can then create, organize and communicate with their associated referral network, and distribute/receive electronic coupons. The following is a description of the various aspects of an exemplary website and system.

### Joining the Hierarchical Referral System

There are two ways an individual can register to become a member:

### (1) Create an Account

If the email address of an individual has not been sent a referral, that individual can go to the hierarchical referral system website independently and create an account using component 112 shown in FIG. 1B. The sign up process will include email based account verification of that individual's email address. This will help prevent fraud, could allow a usage limitation to a specific group of individuals, and aid in maintaining a clean network. Once enrolled, since the email address of that individual (now a member) had not been sent a referral, that individual will be at the “top” of a referral network. Being at the “top” of a referral network means that no one has recruited that individual to enroll or make purchases as a result of a referral. In order to still provide the guaranteed benefit of the discount coupon, a member at the “top” of a referral network can print coupons that can be used to save money on his or her own purchases at participating merchants. An electronic coupon will not generate a commission when the referrer and the referree are the same member, but usage in this manner is not discouraged, since as it still drives sales to a participating merchant. A members only receives a commission from purchases made as a result of coupons distributed by that member to other members or individuals.

### (2) Individual-to-Individual Invitation

The second, and primary, method to become a member is to receive an electronic invitation to enroll in a referral network of an existing member (the “recruitment process”). Each referral sent from within the hierarchical referral system to an email address that has not previously been enrolled in the hierarchical referral system includes an electronic invitation to sign up under the referrer's referral network within the hierarchical referral system. A recipient of such a referral is not required to create an account in order to use the electronic coupon. However, once an individual is recruited by a member, if he or she chooses to be a hierarchical referral system user and create an account, that individual is required to sign up under one of the members who have recruited them. In the event the individual has been recruited by multiple members, the hierarchical referral system is designed to allow an individual to select a member under which that individual would like to enroll. In the event an individual does not want to enroll under one of the members recruiting that individual, the system allows an invited individual to make a “request” to enter the system independently. In one embodiment, this process may be discouraged, and the individual may be advised of a possible delay in enrollment as a result.

“Recruited” is defined as sending an individual an electronic invitation (as part of a referral) from within the hierarchical referral system by entering that individual's email address or mobile phone number. Recruiting and referring a purchase represent the same action. In cases where multiple people invite the same individual, the individual can select to join the hierarchy of any of the individuals who sent an invitation, regardless of who sent the invitation first. If a recruited individual wishes to move to another hierarchy, that individual must close his or her existing account and reenroll in the system.

When a hierarchical referral system account is closed, the member closes the account permanently, without exception. As a result, the member also surrenders his or her tiered location within the referral network, and credit for all accumulated referral coupons and future commissions not yet delivered as a result of referrals sent. If an account is closed, the affected referral network adjusts as appropriate, with the first recruit of the member closing the account moving into the superior role and so forth down the hierarchy, all members being notified of the same change in their status in the tiered referral hierarchy. Funds earned are automatically dispersed to the individual closing the account, electronically (with the individual bearing the transaction fee) upon account closure. The member also receives an email confirmation that the account has been closed. A hierarchical referral system account can be closed using component 112 of FIG. 1B.

Every twelve months, the hierarchical referral system network in its current state expires, although a member's account/profile and commissions earned remains active. In one embodiment, the hierarchical referral system allows only individuals with college or university email addresses to enroll. This helps facilitate limiting new enrollment to active individuals, as college and university email addresses are singular by individual and eventually become unavailable when an individual or member graduates or stops taking classes.

### Website Details

When a member creates an account and logs into the hierarchical referral system, the member is presented with a set of tools that enable the member to manage his or her referral program. Some of these tools include:

Personal Profile Manager—Each member who registers can create a personal profile using component 114 of FIG. 1B. This provides a social aspect to the system as well as allows someone who has been recruited and is creating an account to verify the identity of the existing member that they are signing up “under.” Select security procedures and the option to “make private” each member's personal information are included to ensure the safety of those members posting a profile.

Coupon/Recruitment Generator—In order to earn rewards, a member may send out discounts in the form of percentage discount (percentages may vary) coupons to individuals or other members. If those individuals or other members use the coupon, the sender (and others up the chain) receive a percentage of the profits from the sale. A tool is provided on the website for the member to send these coupons via email or mobile text message (SMS). When sent, the coupon appears to originate from the member's personal email address (or name and phone number in the event SMS text messaging is used) that is sending the referral from within the referral system to increase the likelihood that the message is read.

A member can send out a specified, limited number of referrals on a daily basis. These referrals cannot be accumulated and, if unused, are purged at a specified time every night. The hierarchical referral system then creates a specified number of referrals available for distribution the following day. In addition to the electronic coupon, an electronic invitation to join the hierarchical referral system is included as part of each referral. In the event an email referral is sent, an embedded, unique hyperlink directs the referred individual (referree) to a streamlined version of the hierarchical referral system enrollment form (for example, no entry of email address or name is needed) in effort to quickly get that referree through the enrollment process. In the event an SMS mobile text message is sent, a “coupon code” is included in the text message that can be used at the merchant point of sale to apply the associated discount. The SMS mobile text message also informs the referree of the invitation to enroll in the hierarchical referral system.

If a referree enrolls in the hierarchical referral system or uses the email or SMS based electronic coupon when making a purchase in the store, the referree gets an additional “bankable” referral to be sent. This type of referral will not expire, can transfer to the next day, and is stored separately as “bankable” referrals. As a member builds his or her network (sent referrals generate successful purchases or additional enrollments), that member is rewarded with “bankable” referrals that can be sent anytime.

The hierarchical referral system includes a complaint filing mechanism as a part of the referral sent. If an individual sends unwanted referrals and a defined number of complaints are filed, a referral can be removed from the “bank” or from the number of “non-bankable” referrals allocated per day. Although unlikely because of the nature of the way referrals are allocated, if the system is continuously abused by a member, that member's account can be suspended or terminated. Measures to determine and report abuse will be specified and made available to members, and enforced by the owner of the hierarchical referral system. In one embodiment, only “yourschool.edu” addresses can be used to enroll and, as a result, a suspended member will not be able to re-open their account under a different email address if suspended.

Performance Summary and Referral Tracking—A member can view any activity generated on the hierarchical referral system website using component 116 of FIG. 1B. This includes when and to whom referrals were sent, if the referrals were read, if the referral electronic coupon was used, the number of referrals who have signed up for the hierarchical referral system, as well as the total amount of commission earned. Other interesting statistical information will be given as it presents itself The hierarchical referral system will provide as much interesting information as possible to keep members coming back, without raising privacy concerns. Anonymous quantitative statistics may also be shown (for example, 362 referrals sent today, $1,122 dollars earned today).

Network View and Communication—A member can see who he or she signed up under, as well as those who have signed up under them in the hierarchical referral tiers. A member can also request the establishment of a “social connection” to a member in a referral network outside of his or her referral network if that member knows the enrolled email address or first and last name. Viewing of the global and local referral network takes place through the use of an interface such as a hyperbolic tree. Member associated and “socially connected” referral networks can also send “secure messages” through an in-application based messaging system and “message broadcasts” to each other from within the hierarchical referral system. By default, a member will only be able to see and communicate to one level above that member's tier, and all levels or tiers below. Making a social connection allows both involved parties to view each other's profile and communicate accordingly using communication tools provided within the hierarchical referral system. Both parties must agree in order to establish a social connection. The network view and communication functions are enabled by component 118 of FIG. 1B.

### Electronic Coupons

Electronic coupons are a substantial part of what make this application valuable. If an individual can go to the merchant and get a discount on anything he or she buys, and in one embodiment, a percentage of extra cash for textbooks that individual sells back, it provides a significant incentive to go to a participating merchant (instead of a competitor). Likewise, if that individual knows if he or she is part of a system where other members benefit from use of the coupons, and that individual can benefit from people using his or her electronic coupons, that individual will again be more likely to go to the participating merchants (instead of a competitor).

Electronic coupons would be emailed from an existing member to any email address bearing a valid format. In one embodiment, this means only email addresses bearing the “.edu” extension. Each coupon displays the name and email address of the member (referrer), as well as the name and email address of the recipient (referree). Electronic coupons include the name and email address of both parties and are also one-time-use to discourage referrees from potentially printing thousands of coupons and distributing them.

Electronic coupon “codes” can also be delivered via SMS text messaging to mobile devices. If a SMS text message coupon is sent, it will be delivered to the mobile device as a “coupon code” to be entered on a keypad by the referree (or by the cashier) at the point of sale. Each SMS coupon code will display the name and phone number of the referrer, as well as the name and phone number of the referree. SMS coupons are also one-time-use to discourage referrees from posting the codes on the internet or mass emailing them to others.

Additional printable coupons are made available to members anytime through the hierarchical referral system website. Once a member is logged into the hierarchical referral system, he or she will have access to print coupons as desired. These coupons will contain the name and email of the member “above” them as well as that member's name and email. Credit for using these coupons will be given to the member above. The availability of additional coupons is explained briefly in the electronic message portion of a referral. Top level members may print coupons for themselves, but will not receive a percentage of the sale.

Each electronic coupon contains a unique identifier (via barcode or text based coupon code) in order to ensure single use and to correctly allocate appropriate commissions. Merchant point of sale systems can verify coupon status and track usage, as well as deliver data to the hierarchical referral system for processing on a nightly basis, for example, to facilitate system reaction as a result of the use of an electronic coupon.

### Accessing Funds

Commissions earned as a result of a sale appear in the member's “commission account” located within the hierarchical referral system, and are available for external distribution 14 days after the purchase is finalized, for example. Access to funds is available in three ways:

(1) Through an online payment service (OPS) account. A member can request an OPS payment at any time, provided that member has an OPS account. For this instant access to funds, the member is required to pay the necessary transaction fees. The owner of the hierarchical referral system has the option for this to be the primary manner for members to request dispersion.

(2) If an member wishes to avoid OPS fees, he or she may request a paper check be sent via mail upon accumulating a specified dollar amount (for example, fifty dollars ($50.00)) or more in that member's commission account. A check will be mailed to that member directly from the owner of the hierarchical referral system.

(3) The member can use accumulated commissions as an instant merchant credit. The member can select a merchant and print a “credit voucher” from within the hierarchical referral system. Any commission the member has in his or her account can be applied toward a purchase at a participating merchant. Other incentives could be created to encourage members to use the funds at a participating merchant through instant in-store credit such as a higher exchange rate on in-store credit.

It should be noted that the hierarchical referral system can be implemented in any suitable computing environment and the components of the hierarchical referral system can be stored on any suitable tangible medium such as a computer storage medium.

Although the present disclosure has been described with reference to preferred embodiments, workers skilled in the art will recognize that changes may be made in form and detail without departing from the spirit and scope of the disclosure.

What is claimed is:

1. A hierarchical referral system comprising:
a user interface configured to enable a referrer to create an electronic message;
a computation component configured to generate a unique electronic coupon and to generate a unique electronic enrollment invitation; and
a message handling component configured to attach both the electronic coupon and the electronic enrollment invitation, generated by the computation component, to the electronic message and to dispatch the electronic message to a referree,
wherein the attached electronic coupon represents a purchase incentive at a participating merchant and the electronic invitation represents an offer to enroll in a referral network of the referrer.

2. The system of claim 1 and further comprising an in-store point of sale component configured to accept the unique electronic coupon and to responsively provide a corresponding purchase discount and a related commission.

3. The system of claim 1 wherein the unique electronic coupon is a printable coupon.

4. The system of claim 3 wherein the printable coupon comprises at least one of a unique barcode identifier and a unique text based coupon code.

5. The system of claim 1 wherein the unique electronic coupon is a unique mobile text.

6. The system of claim 1 wherein the user interface is further configured to enable an individual, not previously associated with the hierarchical referral system, to become a member of the hierarchical referral system.

7. The system of claim 6 wherein the user interface comprises a profile manager that enables the member to create a personal profile.

8. The apparatus of claim 6 wherein the user interface further comprises a performance summary and referral tracking component which enables the member to view activity generated on the hierarchical referral system.

9. The apparatus of claim 6 wherein the user interface further comprises a network view and communication component which enables the member to view a referral network of the member and to communicate with other members in the referral network of the member.

10. The system of claim 1 wherein the message handling component is configured to dispatch the electronic message to the referree if the referree has an electronic mail address that conforms to a predefined format.

11. The system of claim 10 wherein the predefined format is a student electronic mail address format.

12. A method comprising:
receiving a unique electronic coupon from a referrer in a hierarchical referral system; and
utilizing the unique electronic coupon to make a face-to-face purchase from a merchant,
wherein the merchant is a participant in the hierarchical referral system.

13. The method of claim 12 wherein the unique electronic coupon is a printable coupon.

14. The method of claim 13 wherein the printable coupon comprises at least one of a unique barcode identifier and a unique text based coupon code.

15. The method of claim 12 wherein the unique electronic coupon is a unique mobile text.

16. A hierarchical referral system comprising:
an in-store point of sale component configured to accept a unique electronic coupon and to responsively provide a corresponding purchase discount and a related commission,
wherein at least a portion of the related commission is provided to a referrer that sent the unique electronic component to a referree, and
wherein the purchase discount is provided to the referree.

17. The system of claim 16 wherein the in-store point of sale component is a part of a bookstore sales system.

18. The system of claim 16 wherein the unique electronic coupon is a printable coupon.

19. The system of claim 18 wherein the printable coupon comprises at least one of a unique barcode identifier and a unique text based coupon code.

20. The system of claim 16 wherein the unique electronic coupon is a unique mobile text.
